(19) United States
(12) Patent Application Publication
(10) Pub. No.: US 2024/0310696 A1
(43) Pub. Date: Sep. 19, 2024

(54) AUTOFOCUS AND AUTOZOOM RECORDING SYSTEM

(71) Applicant: Tactacam LLC, Caledonia, MN (US)

(72) Inventors: Jeff Peel, Decorah, IA (US); Garrison Peel, Caledonia, MN (US); Benjamin Stern, Holmen, WI (US); Ben Thorud, Holmen, WI (US)

(21) Appl. No.: 18/489,990

(22) Filed: Oct. 19, 2023

Related U.S. Application Data
(63) Continuation of application No. 16/123,379, filed on Sep. 6, 2018, now abandoned.
(60) Provisional application No. 62/556,806, filed on Sep. 11, 2017.

(51) Int. Cl. G03B 13/20; F41B 5/14; F41G 1/36; F41G 1/467; F41G 1/473; F41J 5/10; G03B 29/00; H04N 23/67; H04N 23/69

(52) U.S. Cl. CPC G03B 13/20; F41B 5/1492; F41G 1/36; F41G 1/467; F41G 1/473; F41J 5/10; G03B 29/00; H04N 23/671; H04N 23/69

(57) ABSTRACT

Systems, apparatuses, and methods are described which provide an autofocus and autozoom recording system. The recording system can include, for example, a recording device that can work in conjunction with a rangefinder to autofocus and autozoom even when a target moves. One or both of the recording device and the rangefinder can be mounted on a weapon, for example.

### CROSS-REFERENCE TO RELATED APPLICATIONS

The present application is a continuation of U.S. application Ser. No. 16/123,379, filed Sep. 6, 2018, which claims benefit from and priority to U.S. Provisional Application No. 62/556,806, filed Sep. 11, 2017, the disclosures of the above-identified applications are hereby incorporated by reference herein in their entirety.

### BACKGROUND

Conventional cameras are configured to perform autofocus using contrast detection in which maximal contrast can be equated with maximal sharpness or maximal focus. However, autofocus based on contrast detection can perform poorly where the target is moving. Further, this type of autofocus does not automatically adjust zoom as the target moves closer or farther away.

Further limitations and disadvantages of conventional and traditional approaches will become apparent to one of skill in the art, through comparison of such systems with the present disclosure as set forth in the remainder of the present application with reference to the drawings.

### BRIEF SUMMARY

Systems, apparatuses, and methods provide an autofocus and autozoom recording system substantially as illustrated by and/or described in connection with at least one of the figures, as set forth more completely in the claims.

Various advantages, aspects and novel features of the present disclosure, as well as details of an illustrated embodiment thereof, will be more fully understood from the following description and drawings.

### BRIEF DESCRIPTION OF THE DRAWINGS

FIG. 1 shows an embodiment of a recording system according to the present disclosure.

FIG. 2 shows an embodiment according to the present disclosure of the recording system in which a target object has moved closer to the recording device.

FIG. 3 shows an embodiment according to the present disclosure of the recording system in which a target object has moved farther from the recording device.

FIG. 4 shows an embodiment of the recording system mounted on a bow according to the present disclosure.

FIG. 5 shows an embodiment of the recording system mounted on a rifle according to the present disclosure

### DETAILED DESCRIPTION

As utilized herein, “and/or” means any one or more of the items in the list joined by “and/or”. As an example, “x and/or y” means any element of the three-element set {(x), (y), (x, y)}. As another example, “x, y, and/or z” means any element of the seven-element set {(x), (y), (z), (x, y), (x, z), (y, z), (x, y, z)}. As utilized herein, the term “exemplary” means serving as a non-limiting example, instance, or illustration. As utilized herein, the terms “e.g.” and “for example” set off lists of one or more non-limiting examples, instances, or illustrations.

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all of the components or steps that are illustrated.

Some embodiments according to the present disclosure provide systems, apparatuses, and methods relating to autofocus and autozoom recording systems.

Some embodiments according to the present disclosure provide recording devices that work in conjunction with rangefinders.

Some embodiments according to the present disclosure provide recording device that can automatically adjust one or more of a zoom, a focus, and an angle of a field of view based on distance information to a target. The distance information can be received from a rangefinder, for example.

Some embodiments according to the present disclosure provide that one or both of a recording device and a rangefinder can be mounted on a weapon (e.g., a gun, a rifle, a bow, etc.). Some embodiments according to the present disclosure provide that one or both of a recording device and a rangefinder can be mounted on a portable and/or mobile platform or apparatus. Some embodiments according to the present disclosure provide that one or both of a recording device and a rangefinder can be handheld.

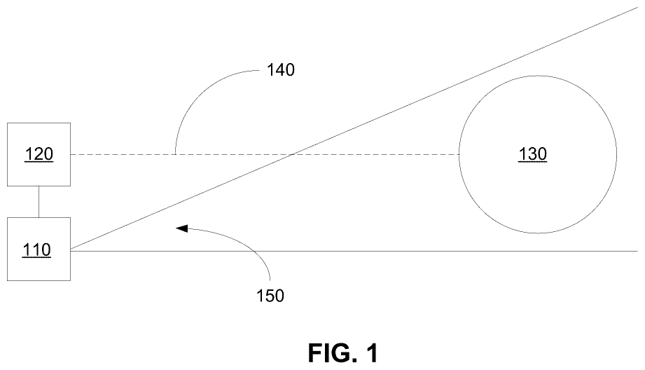

FIG. 1 shows an embodiment of a recording system 100 according to the present disclosure. Referring to FIG. 1, a recording device 110 (e.g., a camera, a video camera, etc.) is operatively coupled to a rangefinder 120 (e.g., an infrared positioning system). The recording device 110 and the rangefinder 120 can communicate using wired links (e.g., a cable, a wire, a line, etc.) and/or wireless links (e.g., cellular, WiFi, Bluetooth, wireless local area network, personal area network, WiMax, satellite, infrared, radio, etc.). In some embodiments, the rangefinder 120 is integrated into the recording device 110, or is inserted or plugged into the recording device 110. The recording device 110 and the rangefinder 120 can include, for example, user interfaces, processors, code (e.g., applications running on the processors, processor-executable instructions, parameters, etc.), transceivers, memories (e.g., non-transitory computer readable storage media storing the code executed or used by the processors) and/or antennas to effect such communications and to cause the recording device 110 to automatically adjust focus, zoom, and/or field-of-view angle based on data received from the rangefinder 120.

In operation according to some embodiments of the present disclosure, the recording device 110 (e.g., a camera) is setup to record (e.g., capturing multiple images) or photograph (e.g., capturing one or more images) a target 130 (e.g., wildlife, an object, etc.). In some embodiments, a user can manually focus the recording device 110, or zoom or change the angle 150 of the field of view to frame the target 130 according to the preferences of the user. In some embodiments, the user can cause (e.g., trigger) the rangefinder 120 to determine the distance 140 to the object 130. The rangefinder 120 then sends this information to the recording device 110 which then automatically focuses and/or zooms and/or changes the angle 150 of the field of view based on the distance information received from the rangefinder 120. In some embodiments, the rangefinder 120 can be triggered (e.g., periodically, aperiodically, after an event, after pressing a button, after pulling a trigger, etc.) by the recording device 110. In some embodiments, the automatic zoom and/or automatic adjustment to the field-of-view angle 150 can be based, in part, on the initial framing of the target 130 (e.g., which might be manually set up by the user or automatically set up by the recording device 110 based on distance information initially provided by the rangefinder 120).

In some embodiments, the rangefinder 120 is configured to transmit and receive electromagnetic waves or sound waves, for example. For example, some embodiments provide that the rangefinder 120 emits an infrared beam that lands on the target 130. A portion of the infrared beam is reflected and is received or sensed by the rangefinder 120 (and/or the recording device 110). Based on the round-trip time or the change in phase of the infrared beam, for example, a distance 140 to the target 130 can be determined. A signal indicating the distance 140 to the target 130 is sent from the rangefinder 120 to the recording device 110. The signal can then be processed by the recording device 110 and, based on the signal, the recording device can automatically adjust one or more of a focus, a zoom, and an angle 150 of the field of view.

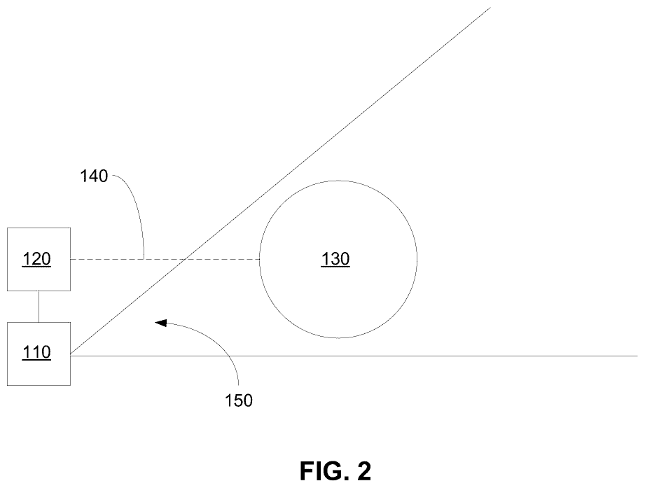

FIG. 2 shows an embodiment of the recording system 100 in which the object 130 has moved closer to the recording device 110. The rangefinder 120 determines the distance 140 to the object 130. The camera 130 receives the distance information from the rangefinder 120. Based on the distance information, the recording device 110 autofocuses and autozooms. As shown in FIG. 2, the recording device 110 automatically adjusts the angle 150 of the field of view of recording device 110 to accommodate the object 130 which has become relatively larger in the field of view of the recording device 110. The angle 150 of the field of view of the recording device 110 is automatically increased as the object 130 comes closer.

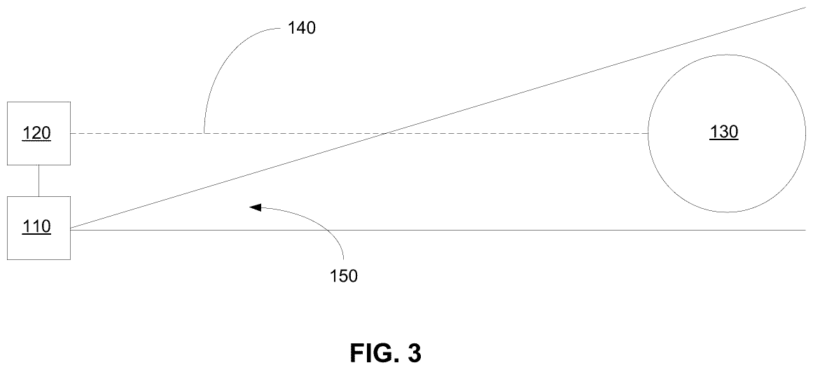

FIG. 3 shows an embodiment of the recording system 100 in which the object 130 has moved farther away from the recording device 110. The rangefinder 120 determines the distance 140 to the object 130. The recording device 110 receives the distance information from the rangefinder 120. Based on the distance information, the recording device 110 autofocuses and autozooms. As shown in FIG. 3, the recording device 110 automatically adjusts the angle 150 of the field of view of the recording device 110 since the object 130 has become relatively smaller in the field of view of the recording device 110. The angle 150 of the field of view of the recording device 110 is automatically decreased as the object 130 moves farther away.

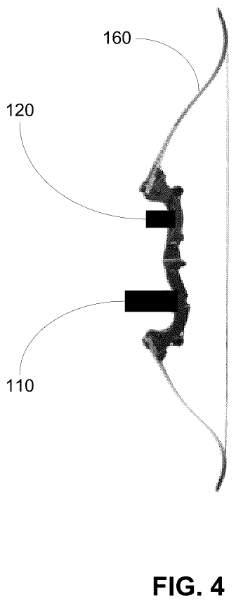

FIG. 4 shows an embodiment of the recording system 110 mounted on a bow 160, for example. As part of the setup of the recording device 110 (e.g., a camera), the view from the recording device can be aligned with the aim point of the bow 160 so that the recording device 110 is capturing images (e.g., pictures, video, etc.) that are the same, substantially the same, or similar to what the user sees through the sights of the bow 160.

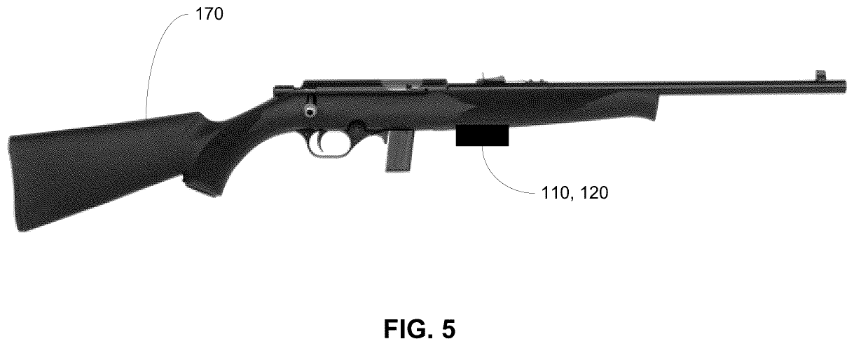

FIG. 5 shows an embodiment of the recording system 110 mounted on a rifle 170. In some embodiments, the recording device 110 (e.g., a camera) and the rangefinder 120 (e.g., an infrared positioning device) can be integrated into a single housing, or the rangefinder 120 can be modular and inserted in the recording device 110. As with the bow 160, once the rifle 170 is zeroed such that the aim point and the impact point coincide, then the recording device 110 is aligned such that the view through the sights of the bow 160 or rifle is the same, substantially the same, or similar to the field of view of the recording device 110. The recording device 110 can be adjusted manually or automatically through a windage adjustment and/or an elevation adjustment.

Some embodiments provide that a button or a trigger can be held down that causes the rangefinder 120 to continuously determine the distance to the object 130 and to send the distance information to the recording device 110. The recording device 110 can make the adjustments to the focus, zoom, and/or angle of the field of view in view of the changing distance information.

Some embodiments provide that a button or a trigger can cause the rangefinder 120 to determine the distance to the object 130 that is lined up with the aim point of the weapon (e.g., a bow 160, a rifle 170, etc.) to which the recording device 110 is mounted.

Some embodiments provide that recording device 110 can transmit the captured images to a display of the recording device 110 and/or a display of another device such as a handheld device (e.g., a smartphone, a computing tablet, a laptop, etc.) and/or wearable device (e.g., glasses, helmet, watch, etc.). In some embodiments, the display can be a heads-up display that is part of a wearable device, for example. In some embodiments, the captured images form a live feed of what is being recorded by the recording device 110 and/or what is in the aim point of the weapon.

Some embodiments provide that the recording device 110 include one or more lenses that can move almost approximately 360 degrees. In some embodiments, the one or more lenses can move independently of the housing of the recording device 110 and can rotate almost approximately 360 degrees. In some embodiments, the one or more lenses can move independently or can move to track the object 130.

Some embodiments provide that the recording device 110 and/or the rangefinder 120 can be handheld. Some embodiment provide that one or both of the recording device 110 and the rangefinder 120 can be mounted on a weapon or some other platform.

While the present disclosure has been described with reference to certain embodiments, it will be understood by those skilled in the art that various changes may be made and equivalents may be substituted without departing from the scope of the present disclosure. In addition, many modifications may be made to adapt a particular situation or material to the teachings of the present disclosure without departing from its scope. Therefore, it is intended that the present disclosure not be limited to the particular embodiment disclosed, but that the present disclosure will include all embodiments falling within the scope of the appended claims.

1. A system, comprising:
a rangefinder; and
a recording device operatively coupled to the rangefinder,
wherein the rangefinder is configured to determine a distance to an object and provide the distance information to the recording device, and
wherein the recording device is configured to automatically adjust focus and zoom based on the distance information provided by the rangefinder.

2. The system according to claim 1, wherein the rangefinder and the recording device communicate wirelessly.

3. The system according to claim 1, wherein the rangefinder and the recording device communicate over a wire or a cable.

4. The system according to claim 1, wherein the rangefinder is an infrared positioning device.

5. The system according to claim 4, wherein the infrared positioning device is configured to transmit an infrared beam that lands on the object to determine the distance to the object.

6. The system according to claim 1, wherein the recording device automatically increases a field of view when the object moves closer to the recording device.

7. The system according to claim 1, wherein the recording device automatically increases an angle of a field of view when the object moves closer to the recording device.

8. The system according to claim 1, wherein the recording device automatically decreases a field of view when the object moves farther away from the recording device.

9. The system according to claim 1, wherein the recording device automatically decreases an angle of a field of view when the object moves farther away from the recording device.

10. The system according to claim 1, wherein the recording device automatically zooms away from the object when the object moves closer to the recording device.

11. The system according to claim 1, wherein the recording device automatically zooms closer to the object when the object moves farther away from the recording device.

12. The system according to claim 1, wherein the recording device is configured to be mounted on a weapon.

13. The system according to claim 12, wherein the weapon includes one or more of a gun, a rifle, and a bow.

14. The system according to claim 1, comprising:
a weapon on which is mounted on the recording device.

15. The system according to claim 1, wherein the recording device includes a horizontal adjustment and a vertical adjustment so that the recording device can be aligned with a weapon aim point.

16. The system according to claim 14, wherein the rangefinder is handheld.

17. The system according to claim 14, wherein the rangefinder is mounted on the weapon.

18. The system according to claim 1, wherein the recording device includes a camera.

19. The system according to claim 1, wherein the rangefinder is integrated with the recording device.

20. The system according to claim 1, wherein the rangefinder and the recording device share a same housing.
